(19) United States
(12) Patent Application Publication
(10) Pub. No.: US 2003/0149616 A1
(43) Pub. Date: Aug. 7, 2003

(54) Interactive electronic voting by remote broadcasting

(76) Inventor: Timothy V. Travaille, Belleville, WA (US)

Correspondence Address: FENWICK & WEST LLP, SILICON VALLEY CENTER, 801 CALIFORNIA STREET, MOUNTAIN VIEW, CA, 94041, US

(21) Appl. No.: 10/071,797

(22) Filed: Feb. 6, 2002

(51) Int. Cl. G06F 17/60

(52) U.S. Cl. 705/12

(57) ABSTRACT

An interactive voting application is broadcast to a broadcast receiver. The broadcast receiver executes the voting application, allowing a voter to cast one or more votes on an electronic ballot, and then transmits the votes to a server. In a preferred embodiment, the server stores the votes so that the voters cannot be associated with their votes.

### BACKGROUND OF THE INVENTION

1. Field of the Invention

The present invention relates generally to electronic voting systems, and in particular to alternative voting systems using a broadcast receiver.

2. Description of Background Art

Existing electoral processes can disenfranchise voters, in part due to reliance on out-of-date voting technology and election methods. For example, more than one third of Americans vote for the president of the United States using an outdated system of punch cards, where voters indicate their choices by removing a paper “chad” from a card. But punch cards, like other existing voting methods, are inherently prone to human error, subjectivity, and variance. Like paper-based ballots, antiquated mechanical voting machines are similarly unreliable.

There have been many innovations in voting systems that address different aspects of the election process. For example, U.S. Pat. No. 3,881,092 describes a voting machine for registering votes on tally counters and punch cards; U.S. Pat. No. 4,015,106 describes an electronic voting machine that stores votes in a computer memory; U.S. Pat. No. 4,510,378 describes a portable voting booth; U.S. Pat. No. 4,649,264 describes an electronic voting machine having a motor-driven scroll mechanism for ballots; U.S. Pat. No. 5,585,612 describes a voting machine that enables illiterate and blind people to vote using audio; and U.S. Pat. No. 5,610,383 describes a device for collecting voting data by reading cards. However, these systems are focused generally on improving some aspect of voting at polling places in accordance with traditional elections. But they do nothing to encourage voter participation by allowing voters to vote at convenient locations (e.g., from the home) and at convenient times.

Voting systems based on computer networks have also been proposed, e.g., wherein voters use their personal computers connected to the Internet to vote from home. For example, U.S. Pat. No. 5,878,399 describes a computerized voting system wherein several voters vote over a computer network. While offering convenience to some, these systems leave behind voters who do not have access to the Internet. They also require expensive investments in additional hardware. In addition, security and privacy on the Internet is often questioned, so election boards and the public are not likely to have confidence in a system where the voters enter their votes via a web site.

Accordingly, new technologies for voting are needed that will address the problems of existing outdated methods. In a public election, a voting system should be accessible, encourage participation, offer privacy to the voters, provide security against election fraud, and accurately reflect the voters' choices.

### SUMMARY OF THE INVENTION

The invention addresses the problems of existing voting solutions by allowing voters to cast their ballots electronically and remotely. In accordance with an embodiment of the invention, registered voters apply to an election board for approval to vote via an electronic broadcast voting system. During a designated voting period, approved voters access a designated voting channel by tuning a broadcast receiver to the voting channel, or otherwise tune the broadcast receiver to receiver to receive an interactive voting application. The interactive voting application is broadcast alone or contained within a broadcast signal on bandwidth associated with the voting channel. The broadcast receiver receives the broadcast, decodes the interactive voting application from the broadcast, and executes the voting application, which is displayed on a television or similar display monitor.

Once the broadcast receiver is executing the voting application, the voter uses the voting application to authenticate him or herself and then cast one or more votes on an electronic ballot. The broadcast receiver transmits the vote data (i.e., the electronic ballot) to a response server, which preferably stores the electronic ballot so that the voter cannot be associated with his or her ballot. Some time after the voter is finished voting, the disassociated ballot data are forwarded to an election board for being tallied.

In one embodiment, an electronic voting system advantageously avoids voting fraud by ensuring that only registered voters who are approved to vote electronically can use the system. Registered voters first apply (e.g., to an election board) to be approved to vote electronically using the system. During the application process, the voter and election board exchange voter-specific information to be used during the authentication process. In one embodiment, this information includes a personal identification number (PIN) supplied by the election board and a piece of secret information supplied by the voter. The voter is authenticated by submitting the voter-specific information using the interactive voting application.

In another embodiment, voters are approved to vote using only a specific set of broadcast receivers, thereby further enhancing security. In an embodiment, electronic responses sent from a broadcast receiver are coded with information that indicates the identity of the broadcast receiver. During the authentication process, the identity of the broadcast receiver that a voter is using is checked against a pre-approved list of broadcast receivers for the voter. The voter is only authenticated if the voter is accessing the voting application using one of the voter's approved broadcast receivers.

In one embodiment, the response server is maintained by a multiple system operator (MSO), which broadcasts, inter alia, the interactive voting application. When the MSO receives an electronic ballot from a broadcast receiver, the MSO preferably stores the associated votes separately from any data that indicates the identity of the voter who cast those votes. The MSO delivers to an election board data relating to the votes cast and the voters that voted. Preferably, this data contains no correlation between the voters and their votes. The election board then tallies the votes in accordance with the rules therefor. The election board can also separately verify which voters have voted using the system. Separating the functions of the MSO and the election board provides anonymity for voters, thus increasing the privacy and security of the overall voting process.

Enabling voters to vote using, e.g., televisions or other electronic voting stations from home and other convenient locations generally improves the election process. In addition to increasing voter participation, the use of televisions (in some embodiments of the invention) rather than computers crosses the “digital divide,” wherein less affluent people cannot participate because they lack the necessary equipment. Because voters own televisions and are highly familiar with them, voting via television enables more people to vote electronically with no additional capital investment by the voter.

The electronic voting system may be provided in addition to a traditional voting system, where voters may choose to participate in either. In various embodiments of elections enabled by the invention, broadcast receivers are advantageously provided in publicly accessible voting stations. Preferably, one or more of these voting stations are located in polling places during an election, so voters may vote at a voting station if the voter's equipment at home is not functioning.

In embodiments of the invention, voters clearly indicate their choices on an electronic ballot, which is preferably shown and confirmed on a display. The invention thus avoids unreliable mechanisms for indicating a voter's selection, such as a punch card's chads. Accordingly, the invention dramatically reduces from the voting process mechanical and human error and subjectivity. dr

### BRIEF DESCRIPTION OF THE DRAWINGS

FIGS. 1A and B show various embodiments of a voting system according to the present invention.

FIG. 2 is an event diagram showing a process for approving voters to vote using a system in accordance with the invention.

FIG. 3 is an event diagram showing a voting process.

FIG. 4 is a flow diagram of an interactive voting application.

FIG. 5 is a block diagram of an interactive broadcast system.

FIG. 6 is a block diagram of an embodiment of a remote broadcast receiver.

FIG. 7 is a flowchart that shows the steps for receiving and operating an interactive application.

### DETAILED DESCRIPTION OF THE PREFERRED EMBODIMENTS

The invention provides an alternative to traditional voting systems by enabling voters to cast their votes using an electronic broadcast reception device, such as a television coupled to a broadcast receiver. In one embodiment of the system, an interactive voting application is broadcast, or otherwise electronically delivered, to a number of broadcast receivers accessible by registered voters. The voters vote for candidates or ballot measures in an election using the voting application, which then returns the vote data for processing and tallying.

Enabling voters to vote from home or any other remote location—e.g., using a television—leads to a number of general improvements in the voting process. For example, allowing voting from home and other convenient locations tends to increase voter participation in elections. In addition, the use of televisions (in some embodiments of the invention) rather than computers crosses the “digital divide,” wherein less affluent people cannot participate because they lack the necessary equipment. Because of cost, more households own a television set than a computer. In addition, people are generally more familiar with televisions than computers, so enabling voting using a television set enables more people to use the system.

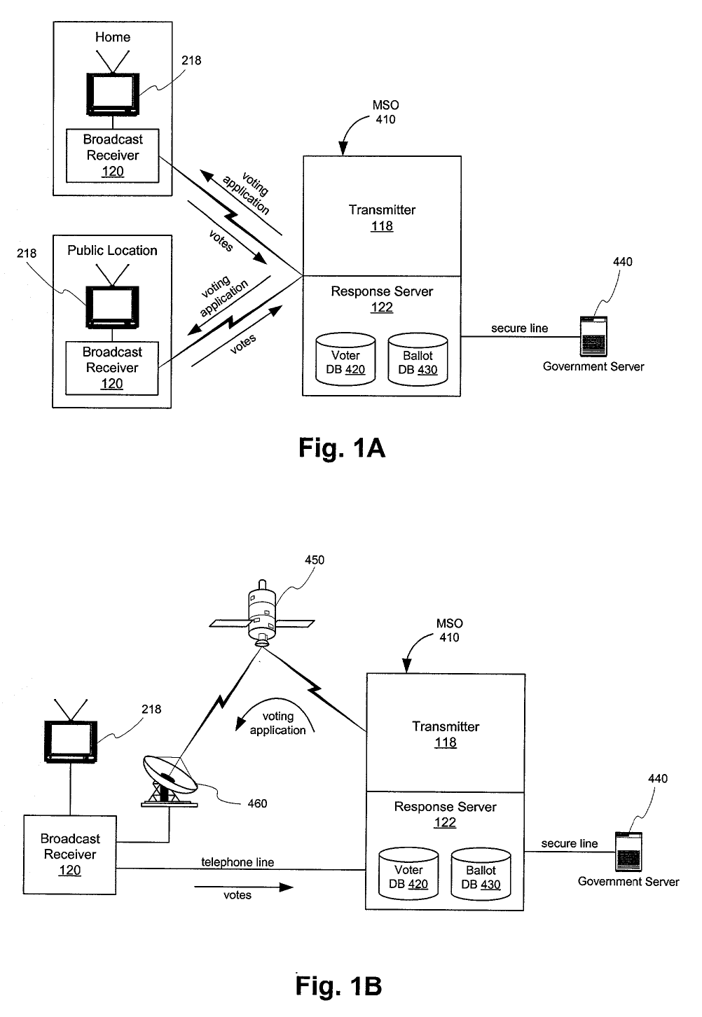

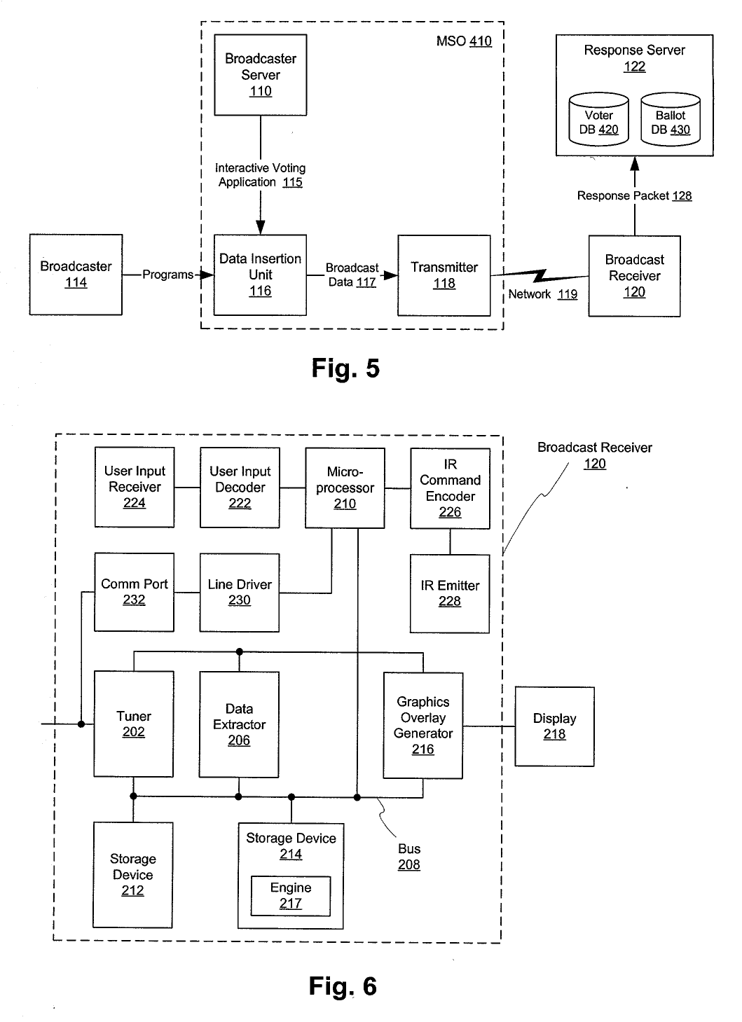

FIG. 1A shows an embodiment of a voting system in which a Multiple System Operator (MSO) 410 transmits an interactive voting application to and receives any associated responses from a broadcast receiver (BR) 120 via a cable system. In one embodiment, the MSO 410 operates the transmitter 118, which is a conventional cable system head-end amplifier. As described below in connection with FIG. 5, the transmitter 118 broadcasts an interactive voting application over the cable or satellite connection to the BR 120, which in this embodiment is a typical cable television set-top box. Although FIG. 1A shows a single BR 120, hundreds, thousands, or even millions of BRs 120 could be served by the MSO 410 in a preferred embodiment. The BR 120 displays the voting application on a display 218, which in a preferred embodiment is a television set. The voter interacts with the voting application to cast his votes, which are then returned to the response server 122 at the MSO 410 for processing.

In a preferred embodiment, the response server 122 at the MSO 410 disassociates a voter's ballot from the identity of the voter, ensuring privacy of the voter's selections. To accomplish this, the response server 122 maintains a separate voter database 420 and ballot database 430. In the present context, a “ballot” is a set of votes selected by a voter, where “set” is understood to mean one or more items in the set. The voter database 420 identifies each voter who submitted a valid ballot for an associated election. The ballot database 430 includes the voters' votes, but it preferably does not associate the identity of each voter with his or her votes. That is, a vote or ballot record in the ballot database 430 preferably contains no data that identifies the voter who cast the vote or votes. In addition, the response server 122 preferably removes from one or both of the voter 420 and ballot 430 databases timestamps and any other information that could be used to correlate a voter and his or her ballot. The voter 420 and ballot 430 databases, therefore, indicate whether a particular voter has voted and how many votes each candidate and ballot measure has received, but they do not allow a third party to determine which votes a particular voter cast.

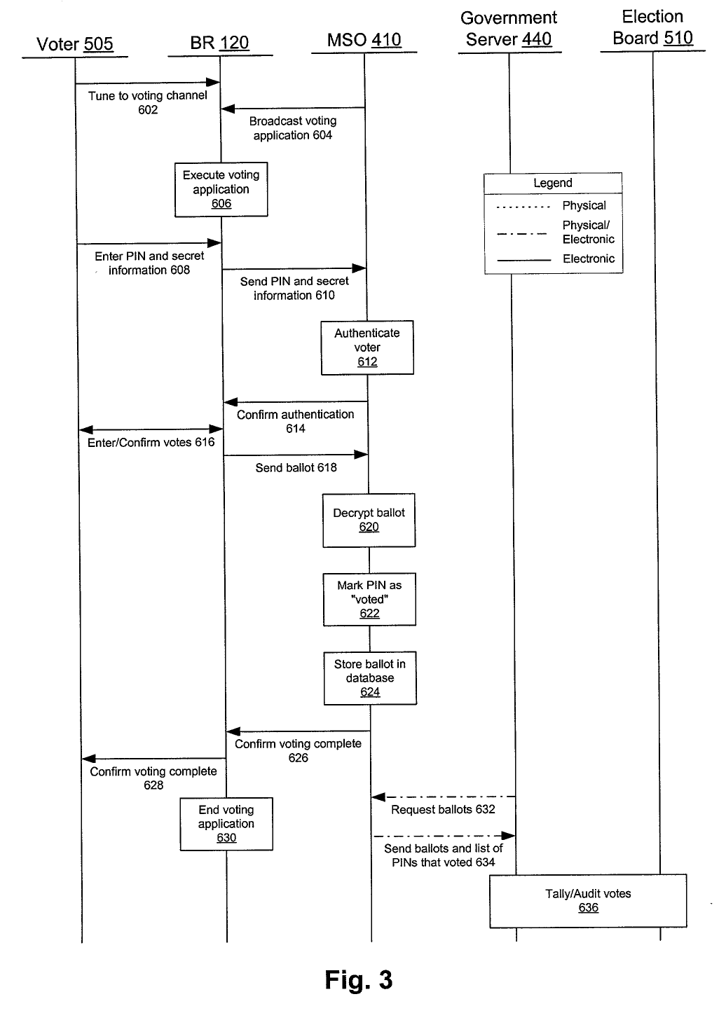

The MSO 410 is coupled to a government server 440, typically operated at the county level. For security and privacy purposes, the MSO 410 is preferably coupled to the government server 440 via a leased line or VPN. The response server 122 is configured to send the voter and ballot data to the government server 440, where the votes are tallied. A more detailed description of this procedure is shown in FIG. 3, described below. In this embodiment, the MSO 410 (1) collects ballots, (2) separates the votes from each voter's identity, (3) stores the votes in a ballot database 430, (4) stores whether each voter voted in a voter database 420, and (5) transfers the ballot data to the election board. The election board then performs the function of tallying the votes. Separating the functions of the MSO 410 and the election board provides anonymity for voters, thus increasing the privacy and security of the voting process.

In another embodiment, the votes may be returned directly from a BR 120 to a government server 420, using, e.g., a phone line connection and modem. In this case, the MSO 410 facilitates the voting, but never has access to any ballots. In another embodiment, the response server 122 is operated by the election board, which additionally performs the functions of the MSO of the other embodiment described.

FIG. 1B shows another embodiment of the voting system in which the MSO 410 transmits the voting application to the BRs 120 via a satellite transmission. In this embodiment, the transmitter 118 at the MSO 410 is a satellite uplink that transmits the interactive voting application to a satellite 450, a satellite downlink 460, and ultimately to the BRs 120. Once a voter completes a ballot, the BR 120 returns the votes to the response server 122 via a telephone line and modem connection, as described below in connection with FIG. 6. Preferably, the BR 120 encrypts the vote data (e.g., using public key encryption or another known technique) before returning the data to the response server 122.

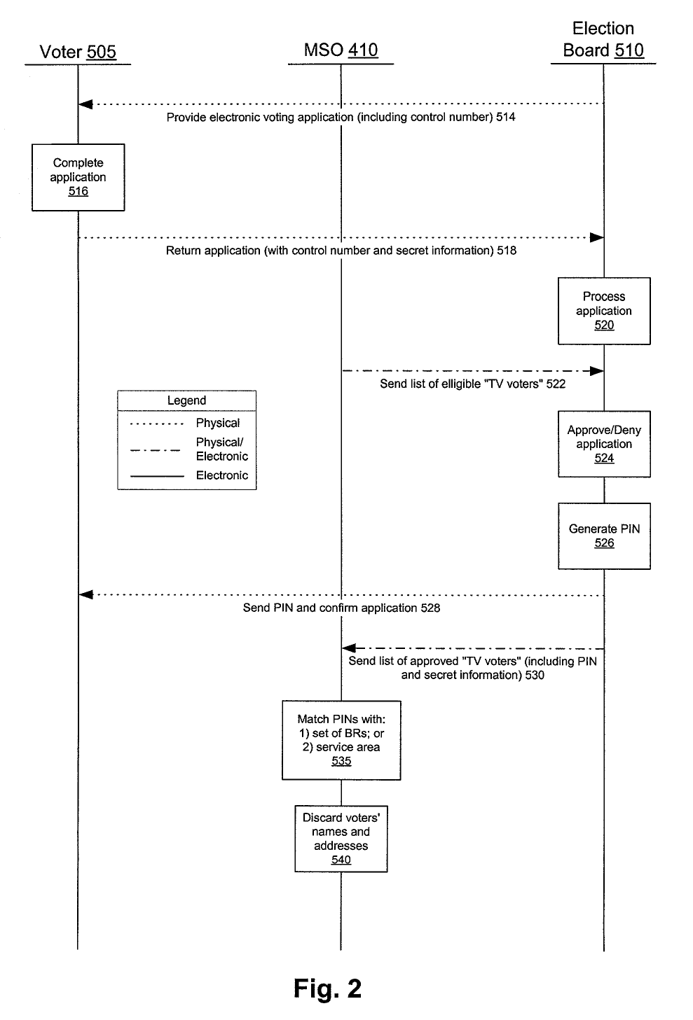

FIG. 2 is an event diagram of a process for approving voters to vote using an alternative voting system in accordance with the present invention. This “alternative” voting system is preferably conducted in addition to other traditional voting methods, including absentee ballots and physical voting where voters travel to a polling place and punch paper ballots to cast their votes. In this way, the additional use of the voting system of the present invention improves voter access to an election. FIG. 2 contains three actors: the voter, the MSO, and the election board; however, in another embodiment the election board performs the functions of and acts as the MSO. Typically, the election board is part of a county government, but the election board can be any entity that conducts an election—governmental or non-governmental. In addition, in an embodiment the MSO is a satellite television or cable system operator, and the voters include subscribers to the MSO's services.

As a preliminary condition in a preferred embodiment, the MSO and election board first agree to conduct an alternative voting system in accordance with the present invention. As a second preliminary condition, the voter registers with the election board to vote using conventional or other means.

In an embodiment of the voting system, voters can vote from remote locations using televisions. Therefore, although there are other embodiments of the system, voters who vote in accordance with the system of the present invention are referred to generally as “TV voters.” Accordingly, the election board 510 sends or otherwise provides 514 to each registered voter 505 an application to be a TV voter. This application is preferably contained within a general election information pamphlet, which may also include an application for an absentee ballot. In one method of conducting an election, voters choose to be TV voters, absentee voters, or traditional polling place voters—the latter being the default if no choice is made. Preferably, a voter 505 may choose no more than one of the available voting options.

If a voter decides to be a TV voter, the voter completes 516 the application for TV voting. This application contains a “control number” that is unique to the voter and used to identify the voter. In addition, to complete 516 the application the voter must enter a piece of “secret information,” which in a preferred embodiment is a number such as birthday, social security number, or other personal information. The voter then returns the application, which includes the voter's control number and secret information, to the election board for processing. Preferably, the TV voter application contains a perforated section that includes the voter's submitted secret information, wherein the voter tears off the perforated section from the application and keeps it until the election.

The election board processes 520 each TV voter application that it receives, similar to how the board would process an absentee ballot application. In processing 520 the application, for example, the election board checks that the voter is a registered voter in the corresponding area and that the voter properly filled out (including the secret information) and signed the TV voter application.

In one embodiment, the election board receives 522 from the MSO 410 a list of subscribers having available BRs 120. Depending on the embodiment of the voting system, the list of subscribers includes the voters or addresses that are cable-enabled (i.e., having the appropriate broadcast receiver equipment, such as a set-top box, to work with the voting system), or the addresses that correspond to customers of the MSO. In one embodiment, the election board validates whether a voter is a subscriber by cross-referencing the voter's address from voter registration records with a list of addresses of subscribers provided by the MSO.

As shown in the embodiment of FIG. 1A, at least some BRs 120 are publicly accessible during the period for voting. For example, in some embodiments voting terminals placed in public locations (such as a library), where any registered TV voter may access and use to vote during the designated voting period. In this latter case, all voters in the designated area are eligible for TV voting, so the MSO 410 need not send 522 a list of eligible TV voters to the election board 510. Additionally, each polling place may have a TV voter terminal and BR 120 in accordance with the present invention. In such a case, the TV voter would have the option of using a TV voting terminal at a polling place. This gives voters the flexibility to vote at home or at the polling place, thereby increasing voter participation and providing a backup for the system, for example when the TV voter's system at home is not functioning.

After receiving and processing a proper TV voter application, and perhaps after verifying that the voter is eligible to be a TV voter, the election board 510 approves or denies 524 the application. If the voter's application is approved, the election board 510 marks the voter 505 as a “TV voter.” As with absentee voters, the election board 510 retains whether each registered voter is a TV voter or a regular polling place voter, which is stored electronically in the government server 440 or with other standard record keeping means. This allows the election board to remove TV voters from the roster of registered voters at each polling place, thus prohibiting a voter from voting twice—once at the polling place using a paper ballot and once via the electronic voting system of the present invention. If the TV voter application is not approved (e.g., the voter is not a registered voter, the application was incorrectly filled out, or the voter is not cable-enabled), the election board notifies the voter of the defect.

In addition, for each TV voter, the government server generates 526 a personal identification number (PIN), which is preferably unique to each voter. The election board 510 sends 528 a confirmation to the voter 505, which confirms that the voter is signed up to be a TV voter and cannot vote with paper ballot at the polls or via absentee ballot. Preferably, the confirmation contains the TV voter's PIN, but does not contain the voter's control number or secret information. The voter 505 is instructed to retain the PIN, in addition to the previously retained perforated part removed from the application that contains the voter's secret information. The voter 505 will use the PIN and secret information when voting later.

In a preferred embodiment, the confirmation contains an absentee-type ballot that includes the voter's PIN. This provides a backup voting method in case, for some reason, the voter cannot successfully vote using the TV voting system. In such a case, the voter fills out the absentee-type ballot and submits it to the polling place. Because the ballot is associated with the voter's PIN, the election board 510 can check whether the voter voted electronically by checking the PIN against a list of PINs for which a ballot was electronically received (which is discussed below). The election board 510 thus discards the ballot if the voter has already voted, but counts the ballot otherwise. The use of the PIN on the backup paper ballot, rather than the voter's name or other identification, further provides anonymity for the voter.

Reviewing an embodiment of the TV voter registration process to this point, three pieces of information are used to identify each voter: control number, secret information, and PIN. At most, however, only two of the three pieces of information are sent in any one communication between a voter 505 and the election board 510. The process employs the control number in communications 514 and 518 to retrieve the voter's secret information. The election board then sends the PIN in communication 528, but without the secret information. To be authenticated in the voting process (described below), voters must provide both their PIN and their secret information. But these two pieces of information are not sent together in a communication between a voter 505 and the election board 510. Accordingly, if any of the communications 514, 518, or 528 are intercepted or otherwise comprised, the integrity of the voting process is maintained.

After a prescribed time when voters can no longer apply for TV voting, or at various times throughout the registration process, the government server sends 530 the MSO a list of approved TV voters. In one embodiment, the list of approved TV voters contains, for each TV voter, the voter's address, PIN, and secret information, but not the control number. The MSO then matches 535 each TV voter's name and address with one or more BRs 120, as the MSO knows the subscriber address at each BR. In a preferred embodiment, a voter 505 is only allowed to vote using a BR 120 to which the voter is matched. Preferably, matches are made by comparing voter addresses with subscriber addresses (i.e., the voter is matched 535 to the BR 120 at his or her home), and optionally by name. Additionally, a TV voter may be matched to additional BRs 120 in the service area. For example, an additional BR 120 is located, e.g., at a public library or other appropriate location. The MSO thus matches this BR 120 to each of the voters or a group of voters, e.g., geographically near the BR 120. In addition, as in the publicly accessible BRs 120, a single BR 120 may have one or more TV voters matched thereto.

The BRs 120 can be identified by a unique identification code associated with therewith. As described below in connection with FIG. 6, each BR 120 preferably has a unique terminal identification code that is included in its responses. This unique terminal identification code allows the response server 122 to identify each responding BR 120.

In another embodiment, the voters are matched not to specific BRs 120, but rather to a general service area. In this embodiment, the election board sends 530 a list of approved TV voters that includes, for each voter, the service area, PIN, and secret information. In this embodiment, the MSO matches 535 each voter 505 to one or more service areas, wherein each TV voter may only vote using one of the BRs 120 in the service area or areas to which the voter is matched.

In yet another embodiment, the approved TV voters are allowed to vote using any BR 120. In this embodiment, the election board sends 535 a list of approved TV voters, including each voter's PIN and secret information. In this embodiment, the election board need not send the MSO the voters' address or service area.

The MSO maintains a list of approved TV voters, the list including each voter's PIN and secret information. In embodiments where TV voters can only vote using certain BRs 120, the list further includes a list of BRs 120 (identified, e.g., by their associated IDs) that each voter can use. Preferably, this list does not include the voters' address.

After the MSO has matched 535 each voter 505 to one or more BRs 120, or if the MSO does not match 535 the voter 505 to any BRs 120, the MSO preferably discards 540 the address information for each of the voters. This increases the voters' privacy in case the security of the voting system is somehow compromised, e.g., by being hacked. In addition, placing the list of approved voters at the MSO decreases the risk that a voter's name and address could be matched to his or her votes.

An example of the information that the MSO maintains for each voter 505 is shown in Table 1, below.

TABLE 1

| Voter PIN | Secret Information | Valid BRs | Voting Status |
|---|---|---|---|
| 111-2222 | 1234 | 5MKS-8FS | Not voted |
| | | 7ZBA-0VG | |
| 333-4444 | 5678 | 5MKS-8FS | Voted |
| . . . | . . . | . . . | . . . |

In the example of Table 1, the voter with the PIN 111-2222 can vote using the BR 120 that has the identification code 5MKS-8FS or the BR 120 that has the identification code 7ZBA-0VG. However, the voter with the PIN 333-4444 can only vote using the BR 120 that has the identification code 5MKS-8FS. In this example, the BR 120 with the code 5MKS-8FS may be a publicly accessible BR 120, which either voter can use (e.g., a publicly accessible voting terminal at a polling place), whereas the BR 120 with the code 7ZBA-0VG may be located in the first voter's home.

FIG. 3 shows an event diagram of an embodiment of the voting process. In one embodiment of the voting process, the TV voters can use the system to cast their ballots during a predetermined period leading up to an election. The election board decides the period in which TV voters can vote electronically. This period can be, e.g., the two weeks preceding the election day, or the election day only.

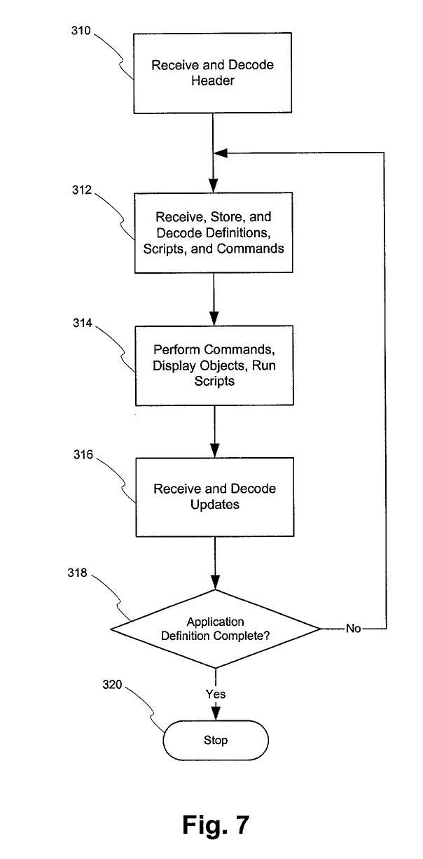

At any time during the voting period, a TV voter 505 can begin the voting process using one of the set of BRs 120 that the voter 505 is approved to use. In a preferred embodiment, the voter 505 tunes 602 to a voting channel using the BR 120. The voting channel in an embodiment is a virtual channel, not corresponding to any actual broadcast bandwidth. Therefore, the MSO broadcasts 604 the voting application as an interactive voting application encoded within the broadcast feed associated with a real channel, such as a community access channel or public broadcast channel. Preferably, this channel is a channel with which there are no other interactive applications associated, so the voting application can be broadcast continuously thereon. Accordingly, when the voter 505 tunes 602 the BR 120 to the designated voting channel, the BR 120 receives the broadcast feed associated with the channel on which the voting application is broadcast, decodes the interactive voting application, and executes 606 the voting application. (This process is described in detail below in connection with FIG. 7.)

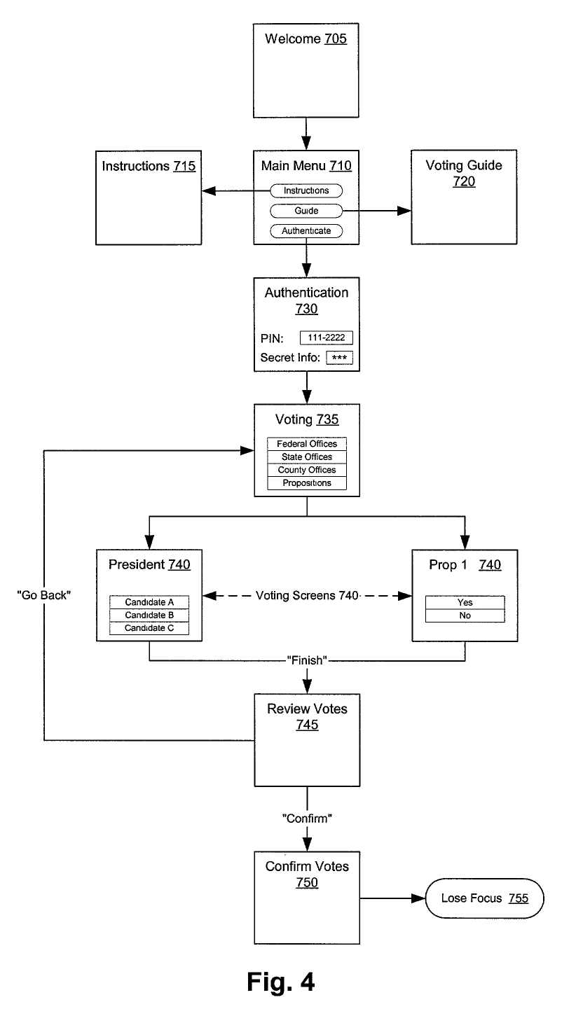

Once the voting application is running on the BR 120, the voter 505 is prompted for the voter's PIN and secret information. (An embodiment of the voting application flow is shown in FIG. 4 and described below.) The voter 505 enters 608 the voter's PIN and secret information. The BR 120 stores the PIN and secret information in its memory 212 and sends 610 the PIN and secret information to the MSO for authentication. The response packet that the BR 120 sends to the MSO preferably includes the BR's identification code, so the MSO knows which BR 120 the voter 505 is using.

In an embodiment, the information shown in Table 1, above, is contained within the voter database 420, maintained by the response server 122. The response server 122 authenticates 612 the voter by comparing the submitted PIN and secret information against the entries in the voter database 420. In an embodiment, if the PIN and secret information combination is found in the voter database 420, the MSO additionally retrieves the list of BRs 120 associated with the voter's PIN. The MSO compares the BR's identification code with this list to verify that the voter 505 is attempting to vote from an approved BR 120. The MSO also checks the voter's status (e.g., “voted,” “not voted,” or “in progress,” as shown in Table 1) to ensure that the voter 505 has not yet voted. The MSO authenticates 612 the voter 505 only if the submitted PIN and secret information (and BR identification code in some embodiments) matches one of the entries in the voter database 420, and if the voter 505 has not yet voted. If the voter 505 is authenticated, the MSO marks the voter's status as “in progress” and confirms 614 the authentication to the BR 120, allowing the voting application running thereon to proceed.

In one embodiment, the MSO confirms the authentication to the BR 120 by establishing a two-way messaging system between the MSO and the BR. For example, where the MSO and BR are coupled via a cable, such as in the embodiment shown in FIG. 1A, a cable modem at the MSO communicates with the BR using an appropriate protocol (such as IP). In another embodiment where the MSO and BR are coupled via a telephone line, such as in the embodiment shown in FIG. 1B, an analog or out of band (e.g., DSL) modem at the MSO communicates with the BR. Those skilled in the art can appreciate that various two-way messaging systems can be used to establish a point-to-point communication between the MSO and each BR.

In another embodiment, the MSO confirms the authentication to the BR 120 by incorporating that information in the broadcast associated with the voting channel. As described, each BR 120 that is tuned into the voting channel is configured to receive and decode information incorporated into that channel's broadcast. This is performed in the same way that the voting application was delivered to the BRs 120 and decoded. Moreover, because the MSO receives each BR's unique identification code during an authentication process, the MSO includes that code with the confirmation broadcast. In this way, the BR 120 for which the confirmation was intended can detect that the confirmation was meant for that BR 120.

In one embodiment, when the MSO authenticates 612 a voter, the BR begins a timer. If a voter does not complete the voting process after a given amount of time, as measured by the timer, the voting process “times out,” and the MSO changes the voter's status to “not voted.” Thereafter, the voter must provide his or her PIN and secret information and be authenticated again before being allowed to vote. This is desirable, for example, when a voter is authenticated but does not complete the voting process. After a given amount of time, it becomes likely that the voter is no longer accessing the voting application. The timeout feature reduces the risk that someone other than the voter will access the voting application while the voter is authenticated, and vote in place of the voter. In another embodiment, the MSO maintains the timer for each voter that is “in progress.” Setting the voter's status to “in progress” prevents voter fraud by not allowing (1) the voter to vote simultaneously on two BRs, or (2) a third party to vote after the voter has been authenticated (e.g., after having observed the voter's PIN and secret information at a public BR).

Once the voter 505 is authenticated, the voter 505 enters 616 his votes using the interactive voting application, which preferably confirms 616 the voter's selections visually. The BR 120 stores the entered votes in its memory 212 as the voter enters 616 them. After the votes are entered and confirmed, the voting application causes the BR 120 to send 618 the ballot, in the form of one or more response packets 128, to the MSO 410. Preferably, before being sent, the response packets 128 are encrypted for security purposes. In an embodiment, a response packet 128 includes the voter's PIN, a list of votes, and the BR's identification code.

The response server 122 receives and decrypts 620 the response packets 128. In an embodiment, the response server 122 uses a standard communications scheme, such as the ALOHA algorithm, to ensure proper transmission of the response packets 128. If the MSO successfully receives a valid ballot, the MSO marks 622 the voter's PIN in the voter database 420 as having voted. In addition, the MSO stores 624 the voter's votes in the ballot database 430.

Preferably, there is no association between a voter in the voter database 420 and the voter's votes in the ballot database 430. Accordingly, MSO preferably stores the votes in the ballot database 430, but not any PINs. In one embodiment, the MSO assigns each ballot or each vote a unique sequence ID number, which is also stored in the ballot database 430 with the associated ballot or vote. Once the ballot database 430 acknowledges that the votes have been stored therein, the MSO confirms 626 to the BR 120 that the voting is complete. The BR 120 further confirms 628 to the voter 505 the successful voting and ends 630 the voting application, wherein the voter can use the BR 120 to receive other broadcasts.

FIG. 4 is a flow diagram of an interactive voting application in accordance with a preferred embodiment. The voting application is displayed on, e.g., a television screen, wherein a voter uses a remote control to navigate through its various screens. The application displays a welcome screen 705 for a given amount of time, and then displays a menu screen 710. Using the menu screen 710, a voter can choose to view one or more voting instruction screens 715, a voting guide 720, or the authentication screen 730. The voting instruction screens provide the voter with instructions for using the voting application. Advantageously, the voting guide 720 provides the voter with information regarding the candidates and ballot measures included in the election, similar to a typical Official Election Guide that some election boards mail to registered voters. In this way, useful information is made available to the TV voters immediately before they vote.

The voter accesses the voter authentication screen 730 when the voter is ready to vote. The voter authentication screen 730 prompts the voter to enter the voter's PIN and secret information. In a preferred embodiment, the PIN and secret identification are numerical, and the voter enters this authentication information using a standard remote control. Once this information is entered, the voting application sends 610 the information to the MSO for authentication (as shown in FIG. 3). If the voter is authenticated, the voting application commences with a voting menu 735, from which the voter can select specific voting screens 740 for particular offices or ballot measures. Once a voter is finished casting his or her votes, the voter selects a “finish” option (e.g., a button), and the voting application displays a review votes screen 745. The review votes screen 745 allows a voter to review each of the votes made, including any offices or ballot measures that the voter may have skipped; thus, the voter can review the selections made and avoid any unintentional non-votes before finalizing the ballot. The voter may return to the voting screens 740 to modify or add to his or her votes. Once a voter is satisfied with the votes, as depicted on the review votes screen 745, the voter may complete the voting process, after which the application displays a confirmation screen 750 to communicate to the voter that the voting is complete.

While the BR 120 is executing the voting application, the voting application controls how the BR 120 responds to commands that it receives from a user (e.g., TV commands such as channel changing). At this time, the voting application is said to have focus. In an embodiment, the voting application controls the BR 120 to disable other TV commands while the voting application is running, preferably preventing the BR from changing channels. Once the voting is complete and the confirmation screen 750 is displayed, the voting application loses focus 755. When the voting application loses focus 755, it no longer controls the BR, allowing the voter to, e.g., tune the BR 120 from the designated voting channel to another channel.

Although only one voter has been described in the voting process, typically thousands or more voters use the system at various times throughout the designated electronic voting period. Often, at any given time, multiple voters use the system to enter their votes at the same time.

Once the voting period is finished, or at various times throughout the voting period, the government server 440 requests 632 the ballots from the MSO 410. Upon receiving a request therefor, the MSO sends 634 to the government server 440 the ballots and the list of PINs showing which voters voted. Alternatively, or in addition, the MSO sends 634 the ballots and list of voters to the government server 634 automatically at predetermined times. For example, the MSO may send the ballots to the government server 440 each night during the voting period. Preferably, the MSO encrypts the ballot data before sending them to the election board. In an embodiment, the MSO uses an available public encryption algorithm, or one provided by a third party.

After the government server 440 receives the ballots and the voting period is complete, the election board tallies the votes 636. Tallying the votes can be performed electronically using the government server 440 or manually, depending on the local election rules and resources. It can be appreciated that electronic tallying is much faster than traditional hand counting.

It can be understood that the MSO can use a variety of reporting methods to send the ballots to the government server 440. In one embodiment, the MSO uses the data in its voter database 420 to compile a report of unused PINs (i.e., voters who did not vote) and used PINs. The MSO uses the data contained in the ballot database 430 to generate a list of votes (i.e., a selection for a particular item on a ballot). Because, in a preferred embodiment, the voters in the voter database 420 are not associated with their votes in the ballot database 430, the reports that the MSO delivers to the election board do not enable the election board to match voters with their votes. In addition, the MSO can provide the election board with lists of both the used and unused PINs, for the purpose of determining voter turnout and other lection statistics.

As explained, in one embodiment, the MSO assigns each vote a unique sequence ID number, which is also stored in the ballot database 430 with the associated vote. This allows cross checking of the voter turnout with the returned ballots. Alternatively, each ballot, which contains a set of votes, is assigned a single sequence ID number. When reporting the ballots to the government server 440 or election board, the MSO preferably includes the sequence ID number associated with each vote (or, with each ballot). This enables the election board to account for the votes received, avoiding counting errors, especially when the election board receives the ballots in several batches at different times.

In one embodiment, the MSO tallies the votes and sends the results, in addition to the list of untallied votes as described above, to the election board. Although the election board may require that government personnel perform the board tallying to avoid fraud, the unofficial tallies reported by the MSO provide a mechanism by which the government can double-check its own count. This further enhances the reliability and accuracy of the voting process.

Alternatively, where the election board does not have a server 440 adapted to receive the ballots electronically from the MSO, the MSO preferably prints out a hardcopy report of the ballots and the voters that have voted. In one embodiment, the MSO tallies the votes and delivers the vote totals to the election board; however, many election rules dictate that the election board tally the votes. In such a case, the MSO can print out ballots that represent the submitted votes, which the election board manually counts in accordance with the law. Given the data held by the MSO, the MSO can be configured to provide any desired counts, totals, or other reports as desired by the election board.

In an alternative embodiment, the election board, not the MSO, performs the authentication. In this embodiment, the voters use the voting application to enter their authentication information and ballots, which their broadcast receivers send to the MSO. The MSO does not perform authentication, and preferably does not have access to the voters'0 authentication information. Rather, the MSO simply collects the electronic ballots (which include each voter's authentication information) from voters as described above, and forwards them to the election board. The election board then authenticates each ballot by checking its authentication information against the election board's database of registered voters. Preferably, the election board discards ballots that have incorrect authentication information or ballots that are associated with the same voter (i.e., ballots that are associated with the same PIN). Alternatively, the electronic ballots have a timestamp that indicates, e.g., when it was created. Where the election board receives multiple ballots from a single voter, the election board may keep the first created ballot and discard the others.

The voting system has been described in connection with public elections; however, the invention is applicable to voting systems and methods outside the public arena. For example, any group or organization that holds an election or uses a ballot for voting purposes can use the technology behind the voting system. The voting system could facilitate elections for groups such as unions, corporations, political parties, NGOs, and the like, where private elections are held to determine certain positions in the organization or to vote on resolutions. In addition, an embodiment of the voting system allows pollsters to more easily collect polling data. In an embodiment of the invention applied to private elections, the roles of the MSO and election board (described in detail above) are combined, and a single actor—such as the organization for which the election is held—performs their actions.

FIG. 5 shows one embodiment of a broadcast system 100 for practicing the present invention. The system 100 illustrated in FIG. 5 may be incorporated into larger, more complex systems while still providing the features and benefits of the invention. Generally, the system 100 includes a broadcaster 114, a broadcast server 110, a data insertion unit 116, and at least one broadcast receiver (BR) 120.

The broadcaster 114 provides program material to be broadcast to the BRs 120. A “program” is a discrete segment of a broadcast; thus, as defined herein, programs include television shows, commercials, public service announcements, pay-per-view events, and the like. Broadcasters 114 include television networks, as well as advertisers who prepare commercials, pay-per-view providers, cable networks, and the like. A typical broadcaster 114 maintains program sources, such as banks of video cassette players, video disc players, film, and the like containing program material; automation systems that selectively control the program sources to select which units provide program material at particular times; and switching systems controlled by the automation systems that couple the program sources to respective broadcast mediums for controlling which program sources output to which broadcast medium at any given time. The person or persons receiving the programs are referred to as “subscribers,” “viewers,” or “voters.”

The broadcast server 110 is preferably a computer system, maintained by the MSO, which provides the functionality described herein. The broadcast server 110 stores one or more interactive voting applications to be broadcast to various remotely distributed BRs 120. In addition, each interactive application preferably has a unique interactive application identification code by which it may be identified. A subscriber uses the voting application to vote for one or more candidates in an associated election (discussed in more detail above in connection with FIG. 3).

In one embodiment of the present invention, an interactive voting application is described by a compact communications protocol. The compact protocol is designed to broadcast a compact set of information and commands among the system components in an efficient manner, thereby allowing the use of low bandwidth transports such as the vertical blanking interval (VBI). A detailed description of one compact protocol for monitoring interactive applications, including supported definitions, scripts, and commands, is described in U.S. Pat. No. 5,689,799, entitled “METHOD AND APPARATUS FOR ROUTING CONFIDENTIAL INFORMATION,” which is incorporated by reference herein. While a preferred embodiment of the present invention uses the compact protocol described therein, interactive applications may be described by other protocols, including for example the Hypertext Markup Language (HTML) and SUN MICROSYSTEMS, INC.'s JAVA language.

In an embodiment, there are a plurality of broadcast servers 110, each broadcast server 110 serving a particular geographic area, set of broadcasters 114, or set of subscribers. Each broadcast server 110 is identified by a unique server identification code.

Generally, the broadcast server 110 determines which interactive applications should be broadcast on a particular channel at a particular time and prepares the interactive applications for broadcast. The broadcast server 110 formats an interactive application 115, if necessary, and otherwise prepares it for insertion into a broadcast signal. The broadcast server 110 passes the interactive application 115 to the data insertion unit (DIU) 116 for incorporation into the broadcast concurrent with the broadcast of the program.

The DIU 116 receives the interactive application 115 from the broadcast server 110 and the broadcast signal, or feed, carrying the program corresponding to the interactive application 115. The broadcast feed may be received from the broadcaster 114. Alternatively, where the broadcaster 114 does not provide the broadcast feed, the broadcast feed is received from a third party such as a network, cable operator, or local television station. The DIU 116 converts the interactive application 115 into a format suitable for insertion into the broadcast feed and transmission therewith as broadcast data 117. In an embodiment, the DIU 116 receives feeds from multiple broadcasters 114 and can insert a separate interactive application 115 into each feed. Likewise, the DIU 116 can simultaneously insert a separate interactive application 115 into multiple channels from the same, or different, broadcasters 114.

The DIU 116 inserts the broadcast data 117 containing the interactive applications 115 and broadcast programs into the broadcast medium. The broadcast medium is the frequency spectrum used to carry the interactive application 115. In one embodiment, the broadcast medium is a standard analog television signal following National Television Standards Committee (NTSC) standards, and the VBI is used as a transport to broadcast the interactive application 115. The transport is the portion of the broadcast medium that carries the interactive application 115.

In one embodiment, the DIU 116 uses conventional methods to insert data defining an interactive application 115 into the VBI of the broadcast feed. The North American Broadcast Teletext Standard (EIA-506) defines the methods and protocols for sending data in one or more lines of the VBI. However, a wide variety of other transport mechanisms are available, including those that broadcast the interactive application 115 separately from the broadcast program. Such transport mechanisms include out-of-band transmitters, which transmit the interactive application 115 on an unused portion of the television frequency spectrum, and conventional frequency modulation (“FM”) radio transmitters, which transmit the interactive application 115 outside the television frequency spectrum. In another embodiment, the broadcast medium is a standard MPEG2 Digital Video Multiplex, containing one or more MPEG2 Video Services, and a MPEG2 elementary stream (or streams) within this multiplex is used as a transport. In another embodiment, the DIU uses conventional methods to insert data into an elementary stream within a MPEG2 multiplex.

In one embodiment, error checking or error correcting codes—such as Hamming codes—are inserted with the broadcast data 117. The DIU 116 translates the data into a Hamming code, and or the data received by the DIU 116 from the broadcast server 114 is already encoded.

The DIU 116 is coupled to a transmitter 118 for transmitting the broadcast feed, including the inserted interactive application. In one embodiment, the transmitter 118 is a satellite uplink transmitting the feed to local uplink receivers, which then distribute the broadcast feed to the BRs 120 via cable. In another embodiment, the transmitter 118 is a conventional cable system head-end amplifier. In yet another embodiment, the transmitter 118 is a conventional television broadcast transmitter or a high-definition television digital transmitter.

The DIU 116 inserts the interactive application 115 into the program before the program is broadcast. For example, the DIU 116 may insert an interactive application 115 into the source copy of a television commercial. In that case, the interactive application 115 is broadcast whenever the commercial is broadcast, and the broadcast server 110 does not need to synchronize the retrieval of the interactive application with the schedule listed in the playlist.

Regardless of transmission method and insertion time, the BRs 120 receive the broadcast data 117, which includes the interactive application 115 encoded therein. Although only a single BR 120 is illustrated in FIG. 5, in a typical embodiment there are hundreds or thousands of BRs 120 that receive the broadcast data 117. In an embodiment, the BR 120 is a television set-top box receiving the data 117 via a coaxial cable. In addition, the BR 120 may be integrated into the television. Moreover, other types of broadcast receivers, including a NTSC broadcast receiver, a high-definition television digital receiver, a videocassette recorder, or a FM radio receiver can also be used.

FIG. 6 illustrates an embodiment of a BR 120 in accordance with the present invention. In one embodiment, the BR 120 is the General Instrument DCT-2000 CATV set-top decoder, or the Scientific Atlanta Explorer 3000 set-top decoder. The BR 120 includes a tuner 202 for receiving the broadcast data 117 from the transmitter 118. In one embodiment, the tuner 202 is a conventional cable television tuner. In other embodiments, the tuner is a television broadcast tuner, a FM radio tuner, a digital tuner, or some other form of tuner. The embodiment illustrated in FIG. 6 shows a display 218, typically a television, within the BR 120. As mentioned above, the display 218 may also be located external to the BR 120.

The BR 120 also includes a data extractor 206 coupled to the tuner 202 for extracting the interactive application from the broadcast data 117. In one embodiment, the data extractor 206 is a conventional VBI in-band data extraction circuit, or a digital out-of-band data extraction circuit. In another embodiment, the data extractor 206 is a conventional modem. The data extractor 206 provides a serial bitstream containing the extracted interactive application onto a bus 208. The bus 208 is coupled to a microprocessor 210 that stores, via the bus 208, the extracted interactive application into a first storage device 212 as instructed by a program stored in a second storage device 214.

In one embodiment, the microprocessor 210 uses the error code information from the extracted data to check or correct errors in the decoded interactive application. In one embodiment, the first storage device 212 is a conventional random access memory (RAM) while the second storage device 214 is a conventional read-only memory (ROM). Other memory types may be substituted for either storage device—including flash memory, which is readable and writeable, yet retains its contents after a power loss. An advantage of flash memory is that software or data resident in the BR 120 can be modified by a received interactive application 115. The first storage device 212 is preferably used to store responses generated by a viewer during use of an interactive application 115.

In one embodiment, the BR 120 also uses the data extractor 206 to extract a time signal from the broadcast data 117. The time signal indicates the current time using a standard timebase, such as Universal Coordinated Time (UTC) or the subscriber's local time. In another embodiment, the BR 120 has a real-time clock that is set either by the subscriber or by the received time signal. Regardless of the method, the BR 120 preferably has access to the current time and, accordingly, can perform date stamping and timing functions.

As described below, the microprocessor 210 uses the program stored in the second storage device 214 and the interactive application 115 stored in the first storage device 212 to execute the interactive application and provide an output. The program stored in the second storage device 214 is preferably an execution engine 217 for executing an interactive application 115 defined by various scripts, forms, definitions, and code and graphic resources. A preferred execution engine 217 is the Wink Engine provided by Wink Communications, Inc. of Alameda, Calif.

The output from executing an interactive application 115 may be, for example, a form presenting information or a menu to a television viewer or for receiving viewer input, or it may be a response containing BR 120 or television usage data or indicating viewer preferences. To this end, the BR 120 preferably includes a graphics overlay generator 216 coupled to the bus 208 and driven by the interactive application 115 stored in the first storage device 212 and the program stored in the second storage device 214. The graphics overlay generator 216 generates a graphical display responsive to the interactive application 115. This graphical display is displayed on a display 218, typically a television, coupled to the BR 120.

In one embodiment, the graphics overlay generator 216 also receives the broadcast signal corresponding to a broadcast program from the tuner 202 to allow simultaneous display of the broadcast program and the graphical aspects, if any, of the interactive application 115. In one embodiment, the microprocessor 210 is also coupled to a user input decoder 222, which is further coupled to a user input receiver 224 to allow the user to communicate with the microprocessor 210 to respond to the interactive application 115. In one embodiment, the user input decoder 222 is a conventional infrared remote control decoder. The user input receiver 224 is preferably a conventional infrared receiver 224 with which the user may use a conventional hand-held remote control device. Remote control keys pressed by the user translate to coded infrared signals that are received by the user input receiver 224, are decoded by the user input decoder 222, and sent to the microprocessor 210 to allow the user to interact with the interactive application 115.

In one embodiment, the BR 120 comprises a cable TV set-top decoder, connected to a cable system via a broadband coaxial cable. In this embodiment, line driver 230 comprises an RF modem that is capable of sending responses via the coaxial cable to the cable system head-end, typically using an out-of-band portion of the RF spectrum, and communications port 232 comprises a standard RF tap. In another embodiment, the BR 120 comprises a television, VCR, or set-top box that is adapted to receive a satellite broadcast from a satellite downlink. In this embodiment, line driver 230 comprises a standard telephone modem and communications port 232 comprises a standard RJ-11 jack.

The microprocessor 210 may also be coupled to a conventional infrared command encoder 226, which accepts an infrared command input and encodes a signal for a conventional infrared emitter 228 to allow the interactive application 115 to control external devices.

Referring to FIG. 5, a BR 120 may execute various interactive applications 115 as the viewer is viewing a broadcast program or a screen generated by the interactive application 115. An interactive voting application allows the viewer to view and interact with displayed menus or forms on the display, in accordance with the application. Responses from the viewer are provided back to a response server 122 for processing, typically after being stored in the first storage device 212 of the BR 120.

In one embodiment, the BR 120 forwards response packets 128 to the response server 122 at particular time intervals, in response to a poll from the response server 122, an interactive application 115, or another device, or at a rate determined by the interactive application 115 that generated the response. Generally, the response server 122 collects the responses once during each polling period. In an embodiment, a typical polling period is 24 hours, and the responses are transmitted during a polling window at the end of the polling period.

Each BR 120 preferably has a unique terminal identification code that is included in the response and allows the response server 122 to identify each responding BR 120. In addition, the BR 120 also preferably includes the interactive application 115 and broadcast server identification codes in the response.

The response server 122 is preferably a computer system executing a software program to receive, decode, and process response packets 128 received from the BRs 120. The response server 122 stores the responses in one or more databases depending on the application. For example, the response server in one embodiment contains a subscriber information database. In an embodiment of the voting system, the response server includes a voter database 420 and a ballot database 430, which are described in detail above in connection with FIGS. 1A and B.

In addition, more than one response server 122 may be used for receiving response packets 128. In one embodiment, where the BRs 120 execute various interactive applications in addition to a voting application, a separate response server 122 is maintained to process the response packets 128 from the voting application. A gateway performs the required routing of responses and other data from the BRs. In this case, the response servers 122 are configured to receive only response packets 128 from the appropriate interactive application. For example, a response server 122 uses the associated interactive application's ID contained in the header of the response packet 128, or some other indication of the type of response. A separate voting response server 122 dedicated to processing response packets 128 from voting applications receives only those response packets associated with the voting application's ID. This enhances the security and privacy of the voting system, because voting data is maintained separately on a secure server.

FIG. 7 is a flow chart illustrating steps for receiving and operating an interactive application 115 using the compact information protocol according to a preferred embodiment of the present invention. The BR 120 receives and decodes 310 an application header record prepared by the broadcast server 110, inserted by the DIU 116, and transmitted by the transmitter 118. The application header record describes the information that follows and contains the interactive application identification code.

The functionality of the interactive application 115 is described by definitions, scripts, and commands that may be encoded and broadcast in any order. The definitions, scripts, and commands are received and decoded 312 by the BR 120 and define the types and forms of responses that may be received when executing 314 the interactive application 115. More particularly, each interactive application 115 includes data defining the type of response and the particular data included in the response. A vote response is a viewer response to a participatory interactive application, such as a voting application.

Some or all of the received interactive application 115 may be stored 312 within the BR 120. In one embodiment, the interactive application 115 is repeatedly broadcast, allowing a BR 120 to tune to a voting channel at any time yet receive the entire interactive voting application 115. Any desired updates to the stored interactive application 115 may be received and decoded 316. If there are additional or updated definitions, scripts, or commands, they may be sent until the application is complete 318.

Other embodiments of the voting system are enabled by the present invention. For example, in addition to voting using a television and set-top box, the BR 120 and display 218 could be implemented using a variety of other technologies. In one embodiment, the voting application is executed on a home networking device, PDA, or the like, which is operatively coupled to the BR 120.

The foregoing description of the embodiments of the invention has been presented for the purposes of illustration and description. It is not intended to be exhaustive or to limit the invention to the precise forms disclosed. Persons skilled in the relevant art can appreciate that many modifications and variations are possible in light of the above teaching. It is therefore intended that the scope of the invention be limited not by this detailed description, but rather by the claims appended hereto.

I claim:

1. A computer-implemented method of collecting votes from at least some of a group of voters, comprising:
broadcasting an interactive voting application to a plurality of remote broadcast receivers;
receiving from at least some of the broadcast receivers authentication information associated with one or more voters;
authenticating the voters by comparing the received authentication information with stored authentication information associated with the voter; and
receiving electronic ballots from the broadcast receivers, each electronic ballot comprising a set of votes inputted into the broadcast receiver by a voter using the interactive voting application.

2. The method of claim 1, further comprising:
delivering ballot data to an election board, the ballot data derived from the electronic ballots and whether the voters have voted, wherein the identities of the voters are not associated with the voters' electronic ballots.

3. The method of claim 2, wherein delivering ballot data comprises electronically transmitting the ballot data to a server controlled by the election board.

4. The method of claim 2, wherein the ballot data includes a plurality of votes, each vote associated with a sequential identification number.

5. The method of claim 1, wherein the stored authentication information was received from an election board.

6. The method of claim 5, wherein the authentication information for each voter includes:
a unique personal identification number assigned to the voter by the election board; and
a secret information item specified by the voter.

7. The method of claim 1, further comprising:
recording the electronic ballots and that the voters have voted, wherein the identities of the voters are not associated with the electronic ballots.

8. The method of claim 1, wherein the authentication information for each voter includes:
a unique personal identification number assigned to the voter by the election board; and
a secret information item specified by the voter.

9. The method of claim 1, wherein authenticating the voters comprises:
determining whether the broadcast receiver from which the voter's authentication information was received is among a set of broadcast receivers pre-approved for use by the voter.

10. The method of claim 9, wherein the set of broadcast receivers pre-approved for use by a voter includes a broadcast receiver in a polling place.

11. The method of claim 9, wherein the set of broadcast receivers pre-approved for use by a voter includes broadcast receivers located in same geographical area as the voter's residence.

12. The method of claim 9, further comprising:
for each voter, determining a set of pre-approved broadcast receivers.

13. The method of claim 12, wherein determining a set of pre-approved broadcast receivers for each voter comprises:
determining a geographic location code for the voter according to the voter's residence; and
including in the set of pre-approved broadcast receivers broadcast receivers at polling places assigned to the voter's geographic location code.

14. The method of claim 1, wherein broadcasting comprises transmitting the interactive voting application via a cable head-end.

15. The method of claim 1, wherein broadcasting comprises transmitting the interactive voting application via a satellite uplink.

16. The method of claim 1, further comprising:
disassociating the identity of each voter from the voter's electronic ballot, so that the voter's votes are not associated with the voter's identity.

17. The method of claim 1, further comprising:
delivering a first and second report to an election board, the first report describing whether a set of voters voted and the second report describing the voters' votes, wherein the voters described in the first report cannot be correlated with their votes described in the second report.

18. The method of claim 1, wherein at least one of the broadcast receivers is located in a polling place.

19. A computer-implemented method of collecting votes from a plurality of voters comprising:
transmitting in a broadcast television signal an interactive voting application to a plurality of set-top boxes, the set-top boxes adapted to receive the broadcast television signal, to extract the interactive voting application from the signal, and to execute the voting application and display the voting application on a television operatively coupled thereto;
receiving electronic ballots from the plurality of set-top boxes, the electronic ballots including a set of votes that the voters selected using the interactive voting application; and
storing the votes from the electronic ballots and data relating to which voters submitted electronic ballots, wherein the voters are not correlateable with their votes.

20. The method of claim 19, further comprising:
transmitting to an election board data relating to the votes and which voters submitted ballots.

21. A interactive method for voting, comprising:
tuning a broadcast receiver to a voting channel, the broadcast receiver receiving a broadcast signal on the voting channel;
decoding an interactive voting application contained in the broadcast signal;
executing the interactive voting application to receive votes from a vote;
creating an electronic ballot from the received votes; and
transmitting the electronic ballot to a remote server.

22. The method of claim 21, further comprising:
submitting authentication information to the remote server.

23. The method of claim 22, wherein the authentication information includes:
a unique personal identification number; and
a secret information item.

24. The method of claim 21, wherein the electronic ballot includes information for authenticating the ballot.

25. The method of claim 24, wherein the electronic ballot is encrypted.

26. The method of claim 21, wherein transmitting the electronic ballot comprises transmit ting the electronic ballot over a two-way cable connection.

27. An electronic voting system comprising:
a broadcaster adapted to transmit broadcast data, the broadcast data including an interactive voting application;
a plurality of broadcast receivers, each broadcast receiver including a tuner adapted to receive the broadcast data from the broadcaster, a processor adapted to decode and execute the interactive voting application, a memory adapted to store the interactive voting application, a voter data input adapted to receive ballot data from a voter, and a communications interface adapted to transmit the ballot data; and
a response server for receiving ballot data transmitted from the broadcast receivers.

28. The system of claim 27, wherein at least some of the broadcast receivers comprise set-top boxes coupled to a television.

29. The system of claim 27, wherein the response server includes:
a ballot database for storing votes from the voting data; and
a voter database for storing whether a voter submitted a ballot, wherein the voters in the voter database are not associated with their votes in the ballot database.

30. The system of claim 27, further comprising:
an interface to a server operated by an election board, the interface for transmitting to the election board data relating to the votes and which voters voted.

31. An electronic voting system comprising:
a broadcaster adapted to transmit broadcast data, the broadcast data including an interactive voting application;
a plurality of broadcast receivers, each broadcast receiver adapted to execute the interactive voting application to receive votes from a voter to create an electronic ballot, and to transmit the electronic ballot; and
a response server for receiving electronic ballots from the broadcast receivers, wherein the response server includes means for disassociating each electronic ballot from the identity of a voter that created the ballot.

32. The system of claim 31, wherein at least some of the broadcast receivers comprise:
a tuner adapted to receive the broadcast data from the broadcaster;
a processor adapted to decode and execute the interactive voting application;
a memory adapted to store the interactive voting application;
a voter data input adapted to receive ballot data from a voter; and
a communications interface adapted to transmit the ballot data to the response server.

33. The system of claim 31, wherein the response server includes means for authenticating the electronic ballots.

34. An interactive voting application for being executed on a broadcast receiver, the application comprising:
an input interface for receiving information from a voter;
an output interface for transmitting data to a remote server;
an authentication module adapted to collect authentication information from the voter using the input interface, and further adapted to transmit the authentication information to the remote server using the output interface; and
a ballot module adapted to create an electronic ballot based on vote selections received from the voter, and further adapted to transmit the electronic ballot to the remote server.

35. The interactive voting application of claim 34, wherein the authentication information includes:
a unique personal identification number assigned to the voter by an election board; and
a secret information item specified by the voter.

36. A broadcast signal transmissible over a broadcast network, the broadcast signal comprising the interactive voting application of claim 34.

37. The broadcast signal of claim 36, wherein the interactive voting application is encoded within a vertical blanking interval of the broadcast signal.

38. The broadcast signal of claim 36, wherein the interactive voting application is digitally encoded within the broadcast signal.

39. The broadcast signal of claim 36, further comprising:
a broadcast program.

40. The broadcast signal of claim 39, wherein the interactive voting application is encoded within a vertical blanking interval of the broadcast signal.

41. The broadcast signal of claim 39, wherein the interactive voting application is digitally encoded within the broadcast signal.
